(19) United States
(12) Patent Application Publication
(10) Pub. No.: US 2024/0317028 A1
(43) Pub. Date: Sep. 26, 2024

(54) INJECTED GLASS WINDSHIELD FRAME

(71) Applicant: Sportech, LLC, Elk River, MN (US)

(72) Inventor: Cory McWhorter, Big Lake, MN (US)

(73) Assignee: Sportech, LLC, Elk River, MN (US)

(21) Appl. No.: 18/608,577

(22) Filed: Mar. 18, 2024

Related U.S. Application Data
(60) Provisional application No. 63/453,267, filed on Mar. 20, 2023.

(51) Int. Cl. B60J 1/00; B60J 1/06; B60R 21/13

(52) U.S. Cl. CPC B60J 1/007; B60J 1/06; B60R 21/13; B60Y 2200/22

(57) ABSTRACT

A windshield mounting assembly for mounting a windshield on a roll-over protection system (ROPS) of a utility terrain vehicle consists of a three-piece frame for holding the windshield. A top frame member attaches to a top portion of the ROPS and two side frame members attach to respective side portions of the ROPS. A lift-off hinge is formed between a top end of each side frame member and a respective end of the top frame member to allow assembly of the windshield mounting assembly without any tools. A channel formed in the top and side frame members receives respective top and side edges of the windshield. A bottom end of each side frame member includes a lateral channel to support a corner of a lower edge of the windshield.

### CROSS REFERENCE TO RELATED APPLICATIONS

This application claims the benefit of U.S. Provisional Application No. 63/453,267, filed Mar. 20, 2023.

### SUMMARY

A windshield mounting assembly for mounting to roll-over protection frame of a utility terrain vehicle (UTV) is disclosed. The windshield mounting assembly includes a windshield and a frame. The windshield has a top edge, side edges and a bottom edge. The frame includes a top frame member connectable to a top portion of the roll-over protection frame, and first and second side frame members that extend generally transverse to the top frame member and are connectable to respective first and second side portions of the roll-over protection frame. The top frame member includes a top edge surface, and the first and second side frame members have a top end and a bottom end. the first and second side frame members are connectable to respective opposite ends of the top frame member. The top frame member has a top channel extending between opposite ends of the top frame member. The side frame members each having a side channel extending from the top end to the bottom end, and a bottom channel at the bottom end of each side frame member that extends transverse to the side channel. The top, side and bottom channels aligned to receive respective top, side and bottom edge portions of the windshield. In one embodiment, the top frame member is configured with a recess at each opposite end of the top frame member, and the top end of each of the first and second side frame members is configured with a post, each post being engageable with the respective recesses of the top frame member to connect the first and second side frame members to the top frame member. In an alternate embodiment, the top frame member is configured with a post at each opposite end of the top frame member, and the top end of each of the first and second side frame members is configured with a recess, each recess being engageable with the respective post of the top frame member to connect the first and second side frame members to the top frame member.

### BRIEF DESCRIPTION OF THE DRAWINGS

FIG. 1 is a front perspective view of a first embodiment of a windshield mounting assembly mounted to a roll-over protection system for a utility terrain vehicle.

FIG. 2A is a partial perspective view of a left half of the windshield mounting assembly of FIG. 1.

FIG. 2B is a partial view of a top left corner of a frame of the windshield mounting assembly of FIG. 2A.

FIG. 3A is an enlarged portion of the bottom left corner of the frame of the windshield mounting assembly of FIG. 2A.

FIG. 3B is a perspective view of an enlarged portion of the bottom left corner of the frame of the windshield mounting assembly of FIG. 3A with a corner portion of the windshield partially shown in phantom.

FIG. 4 is a front perspective view of a front perspective view of a second embodiment of a windshield mounting assembly for a utility terrain vehicle.

FIG. 5 is an exploded front perspective view of the windshield mounting assembly of FIG. 4.

FIG. 6 is a front perspective view of a top frame member of the windshield mounting assembly of FIG. 4

FIG. 7 is cross-sectional view of the top frame member of FIG. 6.

FIG. 8 is an exploded rear perspective view of the top left corner of the top frame member and the side frame member of the windshield mounting assembly of FIG. 4.

FIG. 9 is a rear perspective view of a top portion of the left side frame member of the windshield mounting assembly.

FIG. 10 is a rear perspective view of a bottom portion of the left side frame member of the windshield mounting assembly.

FIG. 11 is a rear view of the top left corner of the windshield mounting assembly of FIG. 4 showing the connection of top frame member with the side frame member.

FIG. 12 is a rear perspective view of the side frame member of the windshield mounting assembly.

FIG. 13 is a bottom perspective view of the windshield mounting assembly of FIG. 4.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

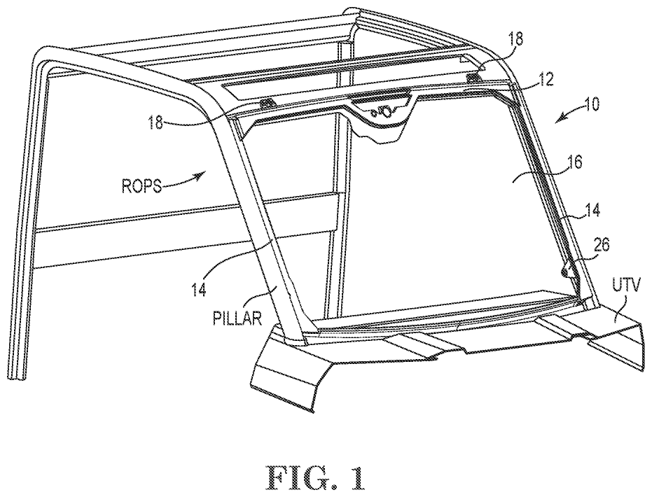

FIG. 1 shows a windshield mounting assembly 10 for utility terrain vehicles (UTVs) that have a roll-over protection system (ROPS) comprised of a frame that mounts to the UTV above the operator. One example of the windshield mounting assembly 10 includes a three-piece frame, with a top frame member 12 and two side frame members 14. Frame members 12 and 14 are made from plastic (e.g., glass filled Nylon, polypropylene, abs, polyethylene, or acrylonitrile styrene acrylate (ASA)) or metal, such as aluminum, and are each formed with a channel sized to receive edge portions of a glass windshield 16, as will be described further herein. In one embodiment, the top frame member 12 is connected to a front transverse beam of the ROPS by hinges 18, and two side frame members 14 that are reversibly connected to the top frame member 12. In the embodiment shown, each hinge 18 is formed from plastic or metal, such as nylon or aluminum, and in one embodiment is integrally attached to the top frame member 12. The portion of hinges 18 that connect to the top frame member 12 form a living hinge that allows flexing of the top frame member relative to the ROPS.

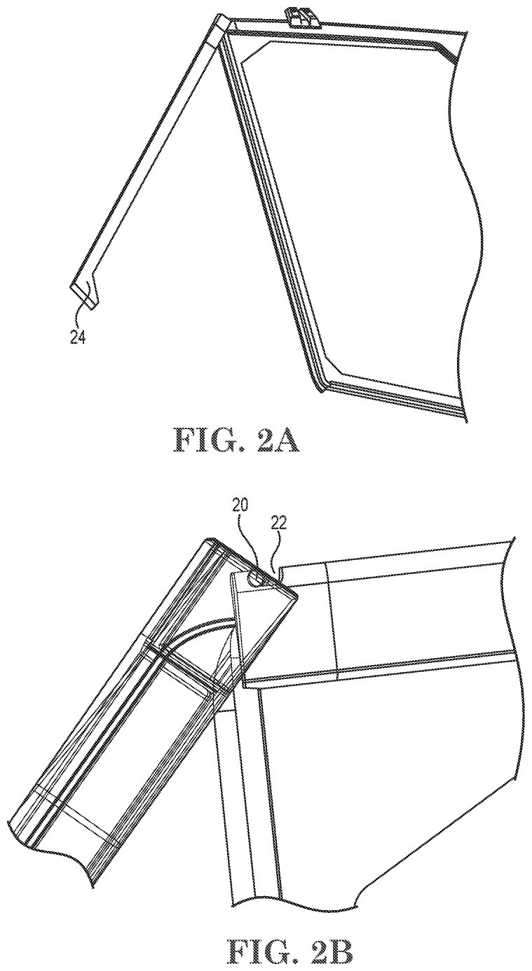

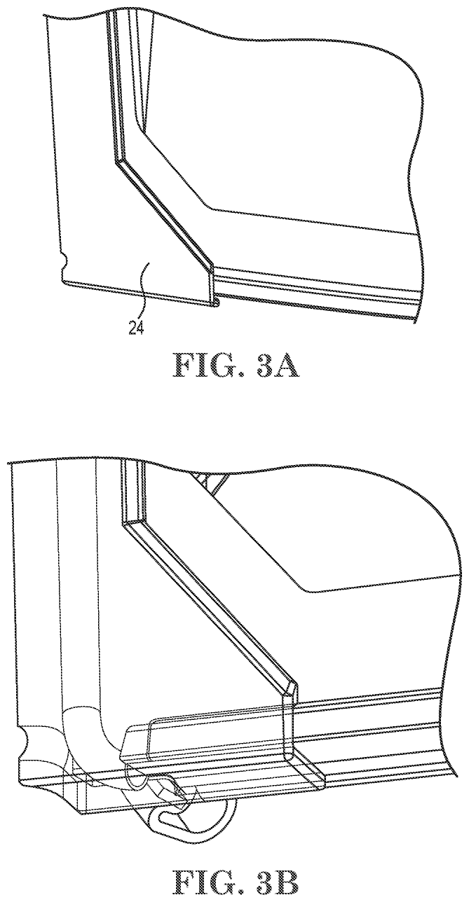

As shown in FIGS. 2A and 2B, in one embodiment the connection of side frame members 14 to top frame member 12 is made by a lift off hinge consisting of a post 20 on each side frame member that fits into a recess 22 formed in the top surface of the top frame member. In one embodiment, recess 22 has a length that is greater than a width of post 20. This connection allows assembly of the windshield support frame without additional hardware or tools. The top and side frame members 12 and 14 each have a channel that receives the windshield. The channels are sized to be greater than the outer dimensions of the windshield to allow the windshield to float (i.e., move) within the channel which absorbs tolerance variations for assembly to UTVs and reduces stress on the windshield when the UTV is jostled, such as on rugged terrain. Each side frame member further has a short transverse frame extension 24 at the lower end of the side frame member to support a portion of the lower edge of the windshield without the need for a full-length bottom frame member (FIGS. 2A, 3A and 3B). The side frame members are secured to a respective front pillar of the ROPS by a removable mount 26 (FIG. 1).

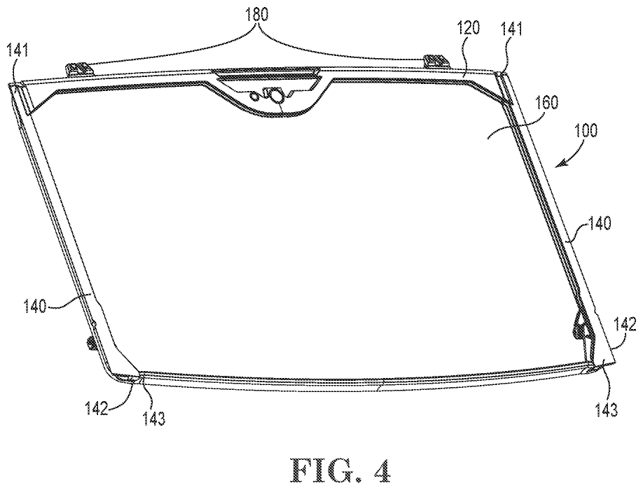

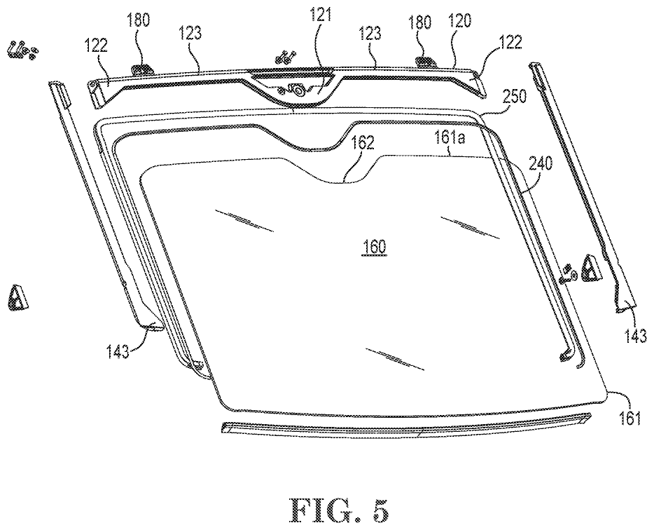

FIGS. 4 and 5 show a second embodiment of a windshield mounting assembly 100, with similar general features described relative to FIGS. 1-3B. As shown in this second embodiment, the edge 161 of windshield 160 has a generally rectangular shape with rounded corners and a generally tapered U-shaped curved portion 162 in the upper edge 161a midway between the side edges of the windshield. The top frame member 120 has a length that is less than the width of the front pillars of the ROPS, but greater than the width of the windshield 160. The top frame member 120 has a width that varies along the length, with a central portion 121, opposite end portions 122 and intermediate portions 123 between the end portions 122 and the central portion 121. The intermediate portions are relatively narrow in relation to the central portion 121 and the end portions 123. The central portion 121 of top frame member 120 is wider than the intermediate portions and has a shape that is complimentary to the curved edge portion 162 of windshield 160. The central portion 121 is configured to mount a windshield wiper motor and related windshield wiper for the windshield. The width of end portions 122 increases gradually from the respective intermediate portions 123 to the respective ends of the top frame member 120. Top frame member 120 defines a channel between the front surface and rear surface along the length of the top frame member 120. A trim piece 240 made of soft foam cord stock is provided to surround the top, side, and lower corner edge portions of the windshield. The foam chord centers the windscreen in the assembly and also absorbs the movement and tolerance variations imparted by the ROPS. A top portion of trim piece 240 friction fits in the channel of top frame member 120. The channel of the top frame member 120 is sized and shaped to receive a top portion of the trim piece before receiving the top edge 161 and top corner edges of the windshield 160.

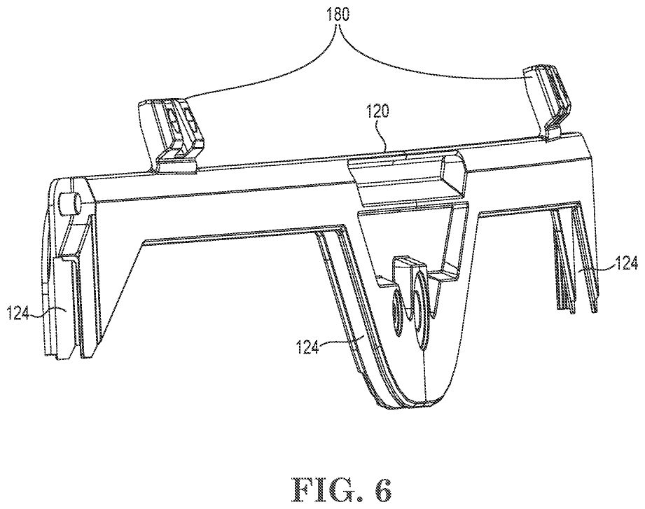

FIG. 6 shows a front perspective view of the top frame member 120 and the channel 124 that extends along the length of the top frame member. The channel 124 has a width that is in close tolerance with the width of the windshield to allow contact between the respective surfaces, yet allow movement of the windshield within the channel. The channel 124 has a depth, i.e., a width, sufficient to overlap the respective edge portions of the windshield to secure the windshield to the ROPS.

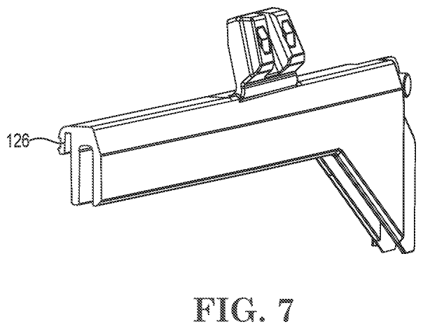

As shown in FIG. 7, which shows a cross sectional view of the top frame member 120 through the intermediate frame portion 123, a short, generally U-shaped wall 126 extends rearwardly and downwardly from a top rear surface of the top frame member 120 along the length of the top frame member 120. The U-shaped wall 126 forms a groove or clip for attaching a trim piece 250 (shown in FIG. 5) and also functions to form a seal relative to the ROPS. In one embodiment, the U-shaped wall 126 is integrally formed relative to the top frame member 120.

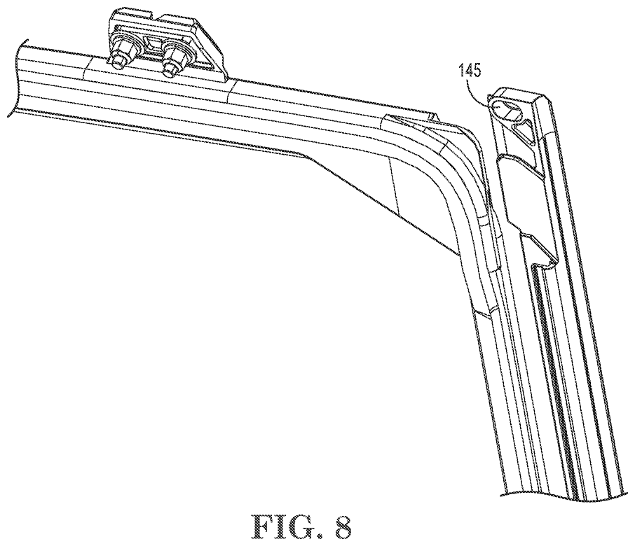

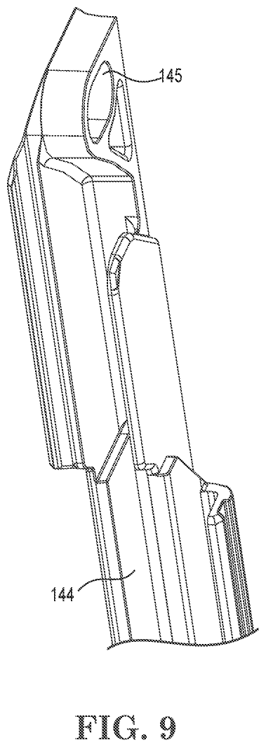

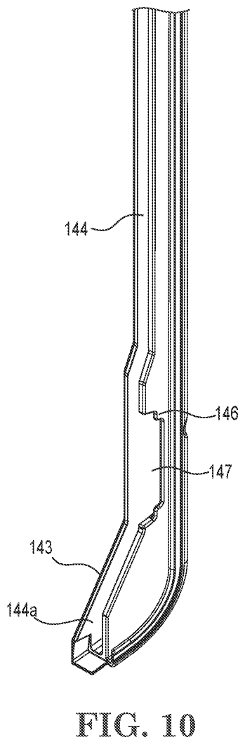

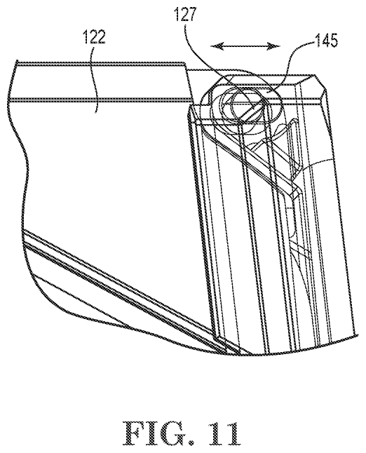

Referring again to FIGS. 4 and 5, side frame members 140 have a length that extends from a top end 141, which connects to the top frame member 120, to a bottom end 142. Side frame members have a width along the length of the side frame members 140. At the bottom end 142, the width of the side frame members 140 gradually increases to form a transverse extension 143. The side frame members 140 each include a channel 144 (FIGS. 9 and 10) along an inside edge that extends along the length and curves to form a lateral channel 144a in the transverse extension 143 (FIG. 10). The channels 144 of side frame members 140 are sized to receive the rest of the trim piece 240 and the side and bottom corner edges of the windshield 160. The top end 141 of each side frame member 140 reversibly attaches to the respective end frame portions 122 of the top frame member 120. As shown in FIGS. 8, 9 and 11, unlike the lift off hinge of the first embedment, in this second embodiment, the top rear surface of each side frame member 140 that faces towards a front surface of the top frame member 120 is formed with a racetrack shaped cavity 145, and the end frame portion 122 of the top frame member 120 is formed with a cylindrical post 127. The cavity 145 has a length that is greater than a width of post 127 and is sized to receive the post 127 yet allow lateral movement of the side frame member relative to the top frame member to allow the side frame members to adjust for tolerance variations of the ROPS.

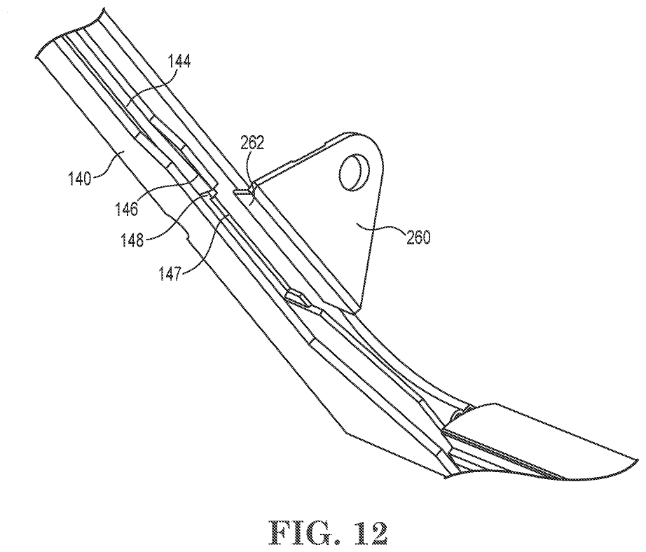

As shown in FIGS. 10 and 12, the inner wall 146 of the side frame members 140 that defines the channel 144 is modified adjacent to the transverse extension 143 of the side frame member to create a mounting site 147 for the removable mount 260. A portion of the inner wall 146 is removed and the thickness of the remaining inner wall is reduced to accommodate a flange 262 of the removable mount 260 that secures side frame members 140 to the ROPS pillars. Flange 262 captures the inner wall 146 and is flush with the inner surface of the inner wall 146. The mount 260 is attached to the pillar of the ROPS to secure the side frame members 140 to the pillar.

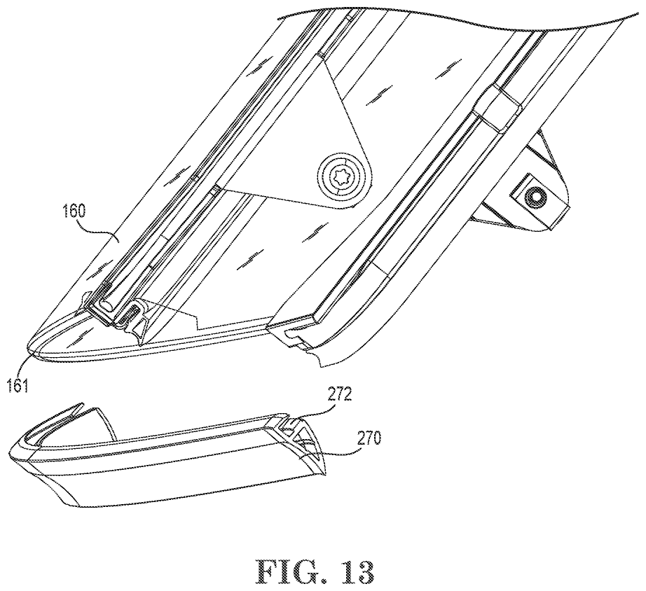

FIG. 13 shows a partially exploded bottom perspective view of the windshield mounting assembly with a bottom windshield trim piece 270 separated from the windshield 160. The bottom windshield trim piece 270 is made from a plastic (e.g., glass filled Nylon, polypropylene, abs, polyethylene, or acrylonitrile styrene acrylate (ASA)) and includes a mounting groove 272 that is positioned over the windshield bottom edge 161 to secure the trim piece to the windshield. The trim piece may be secured to the bottom edge of the windshield with an adhesive.

It is to be understood that the features of the various exemplary embodiments described herein may be combined with each other, unless specifically noted otherwise.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

What is claimed is:

1. A windshield mounting assembly for mounting to roll-over protection frame of a utility terrain vehicle (UTV), the windshield mounting assembly comprising:
a windshield having top, side and bottom edges;
a frame comprising a top frame member connectable to a top portion of the roll-over protection frame, and first and second side frame members extending generally transverse to the top frame member and connectable to respective first and second side portions of the roll-over protection frame, the top frame member including a top edge surface, the first and second side frame members having a top end and a bottom end, the first and second side frame members being connectable to respective opposite ends of the top frame member, the top frame member having a top channel extending between opposite ends of the top frame member, the side frame members each having a side channel extending from the top end to the bottom end, and a bottom channel at the bottom end that extends transverse to the side channel, the top, side and bottom channels aligned to receive respective top, side and bottom edge portions of the windshield, wherein the top edge surface of the top frame member is configured with a recess at each opposite end of the top frame member, and wherein the top end of each of the first and second side frame members is configured with a post, each post being engageable with the respective recesses of the top frame member to connect the first and second side frame members to the top frame member.

2. The windshield mounting assembly of claim 1 wherein the top, side and bottom channels define a space that is greater than the respective top, bottom and side edges of the windshield, such that a windshield mounted in the frame is able to move within the space.

3. The windshield mounting assembly of claim 1 wherein bottom channel of the bottom end of each first and second side frame member contacts only an end portion of the bottom edge of the windshield.

4. The windshield mounting assembly of claim 1 wherein the top frame member includes first and second flexible connectors for connection to the top portion of the roll-over protection frame.

5. The windshield mounting assembly of claim 1 wherein the recess of the top edge of the top frame member has a length and the post of the top end of each first and second side frame member has a width, the length of each recess being greater than the width of each post.

6. A windshield mounting assembly for mounting to roll-over protection frame of a utility terrain vehicle (UTV), the windshield mounting assembly comprising:
a generally rectangular windshield having top, bottom, and side edges;
a windshield frame comprising:
a top frame member connectable to a top portion of the roll-over protection frame, the top frame member having a first end, a second end, a first surface and a second surface spaced from the first surface, the first and second surfaces extending between the first and second end of the top frame member, the first and second surfaces defining a top channel therebetween; and
first and second side frame members each having a top end, a bottom end, a first surface and a second surface spaced from the first surface, the first and second surfaces extending between the top end and the bottom end, the first and second surfaces defining a side channel extending generally transverse to the top frame member, the first and second side frame members being connectable to respective first and second side portions of the roll-over protection frame, the top end of each of the first and second side frame members being connectable to respective opposite end portions of the top frame member, wherein each end portion of the top frame member includes a post and where each top end of the first and second side frame members includes a recess in a rear surface, the recess sized to receive the post to connect the side frame member to the top frame member, the bottom end of each first and second side frame member having a transverse extension, the transverse extension of the first side frame member extending toward and spaced from the transverse extension of the second side frame member, the transverse extension including a transverse extension of the side channel, wherein the top channel, side channels and transverse extension of the side channel are aligned to receive respective top, side and bottom edge portions of the windshield.

7. The windshield mounting assembly of claim 6 wherein the top, side and transverse extension channels define a space that is greater than the respective top, bottom and side edges of the windshield, such that a windshield mounted in the frame is able to move within the space.

8. The windshield mounting assembly of claim 6 wherein transverse extension channel of the transverse extension of the bottom end of each first and second side frame member contacts only an end portion of the bottom edge of the windshield.

9. The windshield mounting assembly of claim 6 wherein the top frame member includes first and second flexible connectors for connection to the top portion of the roll-over protection frame.
